(19) United States
(12) Patent Application Publication
(10) Pub. No.: US 2026/0134573 A1
(43) Pub. Date: May 14, 2026

(54) Three-Dimensional Geospatial Model

(71) Applicant: Niantic Spatial, Inc., San Francisco, CA (US)

(72) Inventors: Eric Brachmann, Dresden (DE); Victor Adrian Prisacariu, Oxford (GB)

(21) Appl. No.: 19/385,594

(22) Filed: Nov. 11, 2025

Related U.S. Application Data
(60) Provisional application No. 63/719,072, filed on Nov. 11, 2024.

(51) Int. Cl. G06T 7/73; A63F 13/216; A63F 13/65; G06T 15/08; G06T 17/05

(52) U.S. Cl. CPC G06T 7/75; A63F 13/216; A63F 13/65; G06T 7/74; G06T 15/08; G06T 17/05; G06T 2200/04; G06T 2207/20084; G06T 2207/30244

(57) ABSTRACT

A system uses models to relocalize a mobile device. The system accesses an input image of a scene in a real-world environment, where the image was captured by a mobile device. The system applies a two-dimensional (2D) foundation model to the input image. The 2D foundation model is trained to determine an image vector representing characteristics of the input image. The system accesses a map representation of the real-world environment, where the map representation includes visual data that describes the real-world environment. The system applies a three-dimensional (3D) geospatial model to the map representation and the image vector. The 3D geospatial model is configured to output 3D splats representing the real-world environment. The system determines a pose of a camera that captured the input image using the 3D splats.

### CROSS REFERENCE TO RELATED APPLICATION

This application claims the benefit under 35 U.S.C. § 119(e) of U.S. Provisional Patent Application Ser. No. 63/719,072, filed on Nov. 11, 2024, which is incorporated by reference.

### BACKGROUND

### 1. Technical Field

The subject matter described relates generally to camera relocalization, and, in particular, to determining a location associated with an image based on map coordinate splats predicted by a machine-learned model.

### 2. Problem

Visual foundation models are large machine learning models, trained on massive amounts of data. They learn powerful representations that are suitable for solving a large variety of diverse vision tasks. A foundation model can be used to, for example, (i) infer 3D geometry (e.g. as points, splats or meshes) from one or more images, (ii) establish correspondences between pairs images, (iii) enable the recovery of pose between pairs of images or a single image and some map, (iv) infer image and scene semantics, and the like.

Most established foundation models, such as DINOv2, CLIP or SAM, are 2D vision models. They have some capacity to solve 3D vision problems, but are prone to generate 3D view inconsistencies, and struggle to cope with large view point changes. DUSt3R and MASt3R (collectively referred to in the following as MASt3R) might be considered an intermediate step towards a true 3D foundation model. Both approaches predict dense local coordinates (re-branded “pointmaps”) for two input images. Based on a single image provided as the “map” of a location, MASt3R can recover metric pose for other “query” images. However, while MASt3R is an improvement from previous 2D vision models, the models are inherently few-view models, structured around two-image inputs. For example, localizing one query image against 1000 mapping images, would require running MASt3R 1000 times. Therefore, scaling an approach using MASt3R is cumbersome and inefficient.

Further, MASt3R produces disconnected predictions per image, i.e. given two images, MASt3R produces points for each image separately, instead of a single point cloud consistent with both images. This limitation becomes particularly apparent in the gaussian splat inference scenario, where MASt3R generates a separate collection of splats for each image instead of a single splat consistent across all the images. This can result in an incoherent, massively redundant, and inconveniently memory intensive number of splats.

### SUMMARY

The present disclosure describes approaches to camera relocalization that use a geospatial model that can augment a mapping of the physical world based on images. The disclosed approach uses a geospatial model that is split into two (or more) sub-models. In one embodiment, the sub-models includes a two-dimensional (2D) foundation model and a three-dimensional (3D) foundation model. The 2D foundation mode is trained to generate vectors from input images that represent meaningful features of the input images. The 3D foundation model is trained such that it distills common information in a global large-scale model of the physical world that enables communication and data sharing across local models. For example, the 3D foundation model may understand the common structure of particular buildings based on its training, such that the 3D foundation model can generate a result that indicates what a side of a building looks like, despite having never received an image or image data related to the building. The geospatial model employs the 2D and 3D foundation models to generate 3D splats for map coordinates corresponding to the physical world, which can be used to locate a device that captured an input image.

The geospatial model can fill in gaps in the mapping of the physical world left by the results from other models. For instance, the geospatial can infer what a physical space looks like based on its knowledge of similar physical spaces. Put another way, the geospatial model extrapolates locally by interpolating globally. These capabilities allow the geospatial model to develop an understanding of viewpoints and angles not actually captured in images input to the geospatial model or any other models that generate data for the mapping of the physical world.

### BRIEF DESCRIPTION OF THE DRAWINGS

FIG. 1 depicts a representation of a virtual world having a geography that parallels the real world, according to one embodiment.

FIG. 2 depicts an exemplary interface of a parallel reality game, according to one embodiment.

FIG. 3 is a block diagram of a networked computing environment, according to one embodiment.

FIG. 4 is a block diagram of inputs and outputs to a geospatial model as used by a geospatial localization module to determine map coordinate splats, according to one embodiment.

FIG. 5 is a flowchart describing an example method of determining location of an input image using a geospatial model.

FIG. 6 illustrates an example computer system suitable for use in the networked computing environment of FIG. 1, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where camera relocalization using a geospatial model is desirable. In addition, the inherent flexibility of computer-based systems allows for a great variety of possible configurations, combinations, and divisions of tasks and functionality between and among the components of the system.

### Example Location-Based Parallel Reality Game

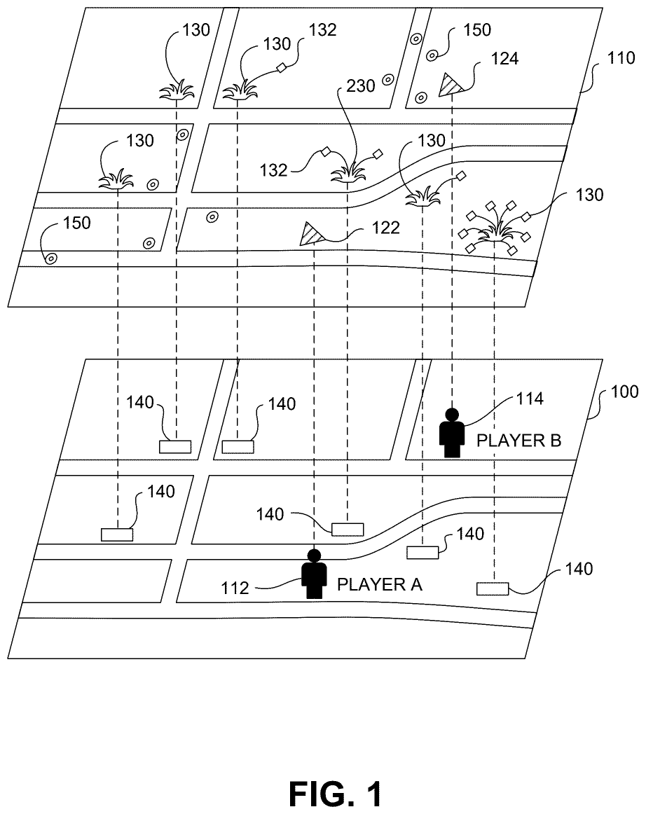

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

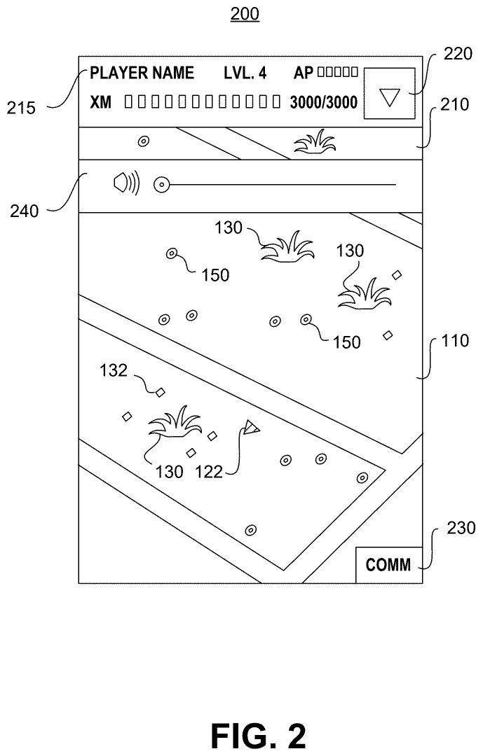

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

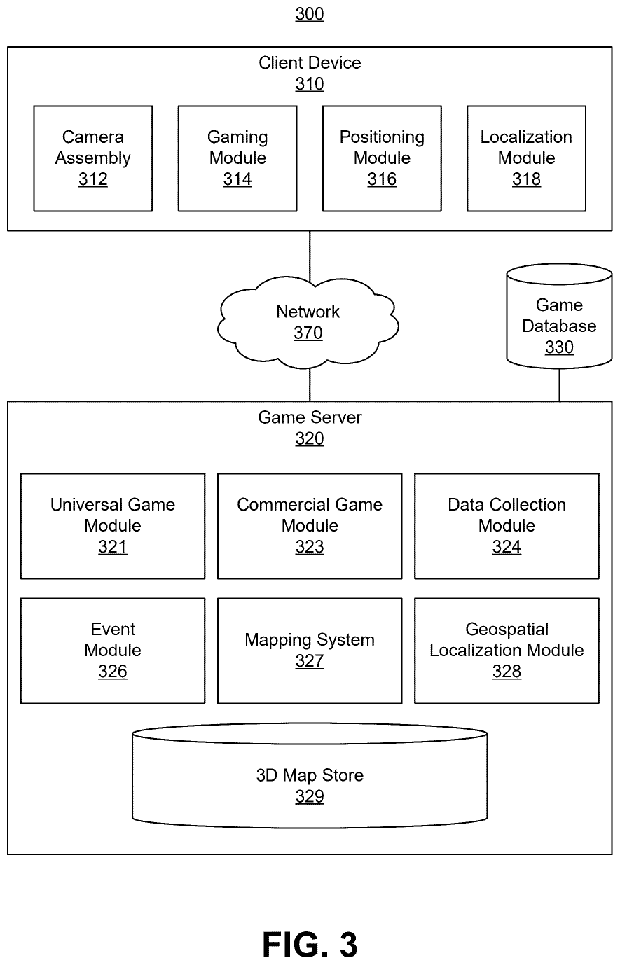

FIG. 3 illustrates one embodiment of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the server 320 in different manners than described below.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a gaming module 314, a positioning module 316, and a localization module 318. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g., to update player position in the virtual world). In addition, any location information associated with players is stored and maintained in a manner to protect player privacy.

The localization module 318 provides an additional or alternative way to determine the location of the client device 310. In one embodiment, the localization module 318 receives the location determined for the client device 310 by the positioning module 316 and refines it by determining a pose of one or more cameras of the camera assembly 312. The localization module 318 may use the location generated by the positioning module 316 to select a 3D map of the environment surrounding the client device 310 and localize against the 3D map. The localization module 318 may obtain the 3D map from local storage or from the game server 320. The 3D map may be a point cloud, mesh, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device.

In one embodiment, the localization module 318 applies a trained model to determine the pose of images captured by the camera assembly 312 relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g., image data used to render the virtual world on a display device, geographic coordinates of locations in the virtual world, etc.); (2) data associated with players of the parallel reality game (e.g., player profiles including but not limited to player information, player experience level, player currency, current player positions in the virtual world/real world, player energy level, player preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of players, current status of game objectives, player leaderboard, etc.); (7) data associated with player actions/input (e.g., current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g., player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 321, a commercial game module 323, a data collection module 324, an event module 326, a mapping system 327, a geospatial localization module 328, and a 3D map store 329. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 321 hosts an instance of the parallel reality game for a set of players (e.g., all players of the parallel reality game) and acts as the authoritative source for the current status of the parallel reality game for the set of players. As the host, the universal game module 321 generates game content for presentation to players (e.g., via their respective client devices 310). The universal game module 321 may access the game database 330 to retrieve or store game data when hosting the parallel reality game. The universal game module 321 may also receive game data from client devices 310 (e.g., depth information, player input, player position, player actions, landmark information, etc.) and incorporates the game data received into the overall parallel reality game for the entire set of players of the parallel reality game. The universal game module 321 can also manage the delivery of game data to the client device 310 over the network 370. In some embodiments, the universal game module 321 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 321. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 321. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

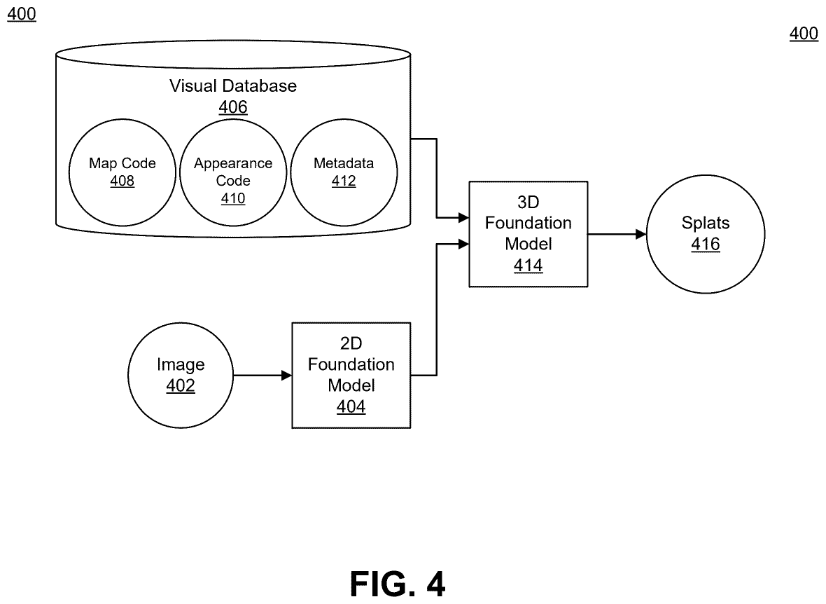

The geospatial localization module 328 uses one or more geospatial models to generate 3D maps (e.g., 3D splats) representing portions of the real world from one or more images of an environment. The 3D maps can then be used to localize client devices 310 within the environment based on images captured on cameras of those client devices. Using one or more of the techniques described below, the 3D map may include information about views of the environment that did not appear in the images used to generate the 3D map. Various embodiments of the geospatial localization module 328 are described in greater detail below with reference to FIG. 4.

The network 370 can be any type of communications network, such as a local area network (e.g., an intranet), wide area network (e.g., the internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

FIG. 4 is a block diagram 400 of inputs and outputs to the geospatial model as used by the geospatial localization module 328 to determine map coordinate splats 416, according to one embodiment. In particular, the geospatial localization module 328 inputs images 402 to geospatial model, which uses two (or more) sub-models to generate the map coordinate splats. The sub-models include a 2D foundation model 404 and a 3D foundation model 414. The geospatial localization module 328 determines an estimated location of a client device 310 that captured an image 402 using the map coordinate splats 416 generated by the geospatial model.

In an embodiment, the geospatial localization module 328 receives image data of a real-world environment (e.g., captured by the camera assembly 125 of the client device 310). The image data may include images 402 or video, which the geospatial localization module 328 can isolate frames from to act as images. For simplicity, the following embodiment is described in relation to images 402 rather than frames from videos. Each image 402 in the image data includes visual information about a real-world environment (of the physical world) the client device 310 is in when the image 402 was taken.

The geospatial localization module 328 inputs images 402 to the geospatial model. The geospatial model includes a 2D foundation model 404 and a 3D foundation model 414. The 2D foundation model 404 is a machine-learned model trained to generate an image vector for an input image 402. The image vector may be a high-dimensional feature vector describing the image. In some embodiments, each pixel in the image may be associated with its own image vector. For example, each 16-by-16 pixel grid (e.g., a patch of 16 pixels horizontally by 16 pixels vertically) in an image may be associated with a 1,000-dimension feature vector describing the pixel grid. For each input image 402, the geospatial localization module 328 receives one or more image vectors from the 2D foundation model 404.

The geospatial localization module 328 retrieves visual data from a visual database 406. The visual data includes map code 408, appearance code 410, and visual metadata 412. The map code 408 includes scene specific information about the environment depicted by each image in the global set of images provided to the geospatial model. The scene specific information may include geometry of the environment, coordinate frame associated with the image, and scale of the scene. The appearance code 410 includes appearance information about the environment depicted by each image. For example, the appearance code 410 may describe time or date-related characteristics of the environment as shown in the image, such as whether the image was captured during the day or at night, in winter or summer, during a rainstorm or blizzard, and the like. The visual metadata 412 includes GPS data, corresponding S2 cell data (e.g., which S2 cell(s) in a mapping of s2 cells to a representation of the physical world corresponds to the GPS data), semantic features and labels (e.g., “urban,” “downtown,” etc.), and the like captured with or in images in the global set of images.

The geospatial localization module 328 (and/or mapping system 327, in some embodiments) may create and store the visual data in the visual database 406 during a mapping stage. The geospatial localization module 328 may perform the mapping stage in response to receiving a request from a user or external operator, at set or periodic times, or based on another triggering condition. In the mapping stage, the geospatial localization module 328 receives user data captured by a plurality of client devices 310 in communication with the game server 320. The user data may include images captured by the client devices 310 and metadata captured by the client device 310 or related to the images, such as GPS data. The geospatial localization module 328 builds the map code 408 and other visual data during the mapping stage based on the user data. In some embodiments, an auxiliary model builds the map code or uses back propagation to further build the map code built by the geospatial localization module 328. The auxiliary model maybe trained on images labelled with map code and other visual data that was captured by the device that captured each corresponding image. The images may be shuffled before training such that the auxiliary model's training is done on un-ordered (e.g., such that images at the same physical location, taken from the same pose, or including the same features due to being taken concurrently are not input to the auxiliary model concurrently).

In one example, the geospatial localization module 328 predicts map code using one or more images of an environment being mapped. In one embodiment, a global set of images may be captured and sent to the game server 320 as incentives for corresponding client devices 310 to complete game objectives for a parallel reality game. The geospatial localization module 328 determines map code and other visual data from the global set and stores the visual data in one or more neural map representations of the data. For example, the visual data may be stored such that each location in a mapped version of the physical world is associated with a network of visual data in the visual database 406.

The geospatial localization module 328 inputs the one or more image vectors and retrieved visual data to the 3D foundation model 414. In one embodiment, the 3D foundation model 414 has a transformer-based architecture. For example, the 3D foundation model 414 may use a framework based on that of an Accelerated Coordinate Encoding (ACE) relocalizer model, which is trained to predict a coordinate for each feature in an image. The ACE relocalizer model 414 is further described in related U.S. patent application Ser. No. 18/542,460, filed Dec. 15, 2023, which is incorporated by reference.

The 3D foundation model 414 is trained to predict 3D splats 416 based on one or more image vectors and a neural map representation of visual data. The 3D splats 416 are renderings of volume data, each representing a map coordinate in a map coordinate plane, such as one that corresponds to a coordinate frame of the physical world. Each 3D splat 416 can be associated with a level of covariance, which represents the captures the variance and correlation of the 3D splat 416. In some embodiments, the 3D splats are Gaussian splats, where each 3D splat 416 is represented by an ellipsoid at its corresponding mapping coordinate and has a particular size, color, and transparency. Thus, when combined, 3D splats 416 may accurately model a physical location's geometry, lighting, and reflections.

Put another way, the 3D foundation model 414 learns a map of the physical world based on the visual data and creates more mappings (in the form of 3D splats) at map coordinates (e.g., coordinates mapped to the real, physical world) corresponding to the image vector(s). In generating the 3D splats 416, the 3D foundation model 414 interpolates the geometry and appearance of a location at a map coordinate that does not have associated visual data (e.g., the gamer server 320 has not received an image of the physical location). This allows the 3D foundation model 414 to learn how particular structures are shaped, what a location looks like based on a time of day, time of year, and the like. For example, the 3D foundation model 414 may interpolate what a fountain looks like from behind based on its knowledge of the visual characteristics of the fountain from the front and of fountains in general, as described by visual data corresponding the global set of images. In another example, the 3D foundation model 414 may generate a 3D splat 416 that represents the physical location at a map coordinate during summer based on its knowledge of what the physical location looks like during the winter and what nearby physical locations look like in the summer.

The 3D foundation model 414 may be a trained by an ACE relocalizer training system. The geospatial localization module 328 may train the 3D foundation model 414 on large scale data, such as a global set of images captured by a plurality of client devices 310 in communication with the game server 320. The training may be supervised based on ground-truth camera poses known for one or more of the images. In some embodiments, the geospatial localization module 328 employs a self-supervised training scheme where earlier checkpoints of the 3D foundation model 414 are used to refine and align images from the global set to mine training data for later-stage checkpoints of the 3D foundation model.

During a query stage, the geospatial localization module 328 receives an image 402 from a client device 310 as part of a query for the pose of the client device 310. The geospatial localization module 328 obtains a map code 408 for the general location of the client device 310 (e.g., by querying a database of predetermined map codes using GPS coordinates of the client device). The geospatial localization module 328 inputs the image 402 to the 2D foundation model 404 and applies the 3D foundation model 414 to the output of the 2D foundation model 404, the map code, and optionally additional visual data for the location from the visual database 406. The geospatial localization module 328 receives 3D splats 416 representative of the physical world at map coordinates corresponding to the image generated by the 3D foundation model 414. The geospatial localization module 404 may determine the pose (e.g., position and orientation) of the client device 310 when the image 402 was captured based on the 3D splats of map coordinates and send the pose to the client device 310.

### Example Methods

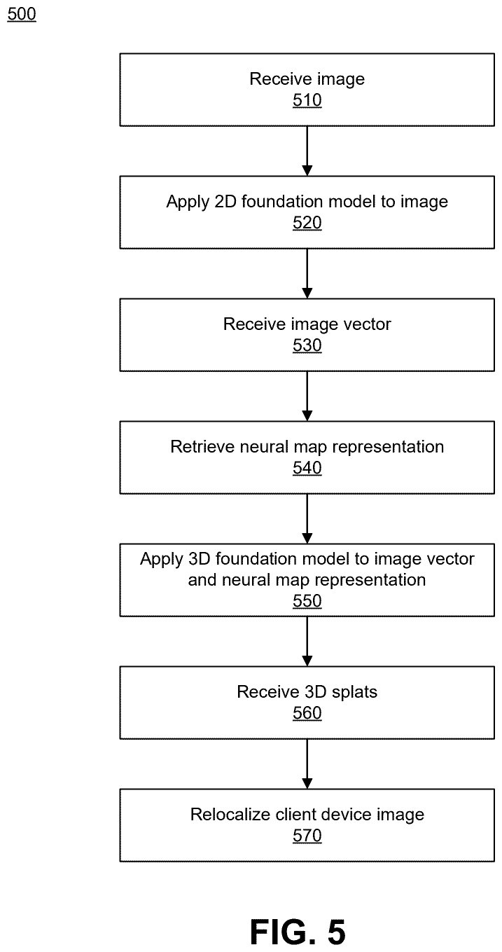

FIG. 5 is a flowchart 500 describing an example method 500 of determining pose of the camera that captured an input image using a geospatial model, according to one embodiment. The steps of FIG. 5 are illustrated from the perspective of the geospatial localization module 328 performing the method 500. However, some or all of the steps may be performed by other entities or components. In addition, some embodiments may perform the steps in parallel, perform the steps in different orders, or perform different steps.

In the embodiment shown, the method 500 begins with the geospatial localization module 328 accessing 510 an input image from a client device 310. The input image may be included in a query for a pose of the client device 310 when the client device 310 captured the image and may depict a scene in a real-world environment (e.g., the physical world). The geospatial localization module 328 applies 520 a 2D foundation model to the input image. The 2D foundation model 404 is trained to determine an image vector representing the input image and its characteristics. The geospatial localization module 328 receives 530 an image vector from the 2D foundation model 404. In some embodiments, the image vector is one of a plurality of image vectors generated from the input image, and each of the plurality of image vectors was generated from a different pixel grid of the input image. The geospatial localization module 328 retrieves 540 a map representation from a visual database 406. The map representation may include map code, appearance code, and metadata connected in a neural network to describe a map of the physical world.

The 2D foundation model applies 550 a 3D foundation model 414 to the data retrieved from the visual database 406 and the image vector. The 3D foundation model 414 may have a transformer architecture and/or a Large Language Model able to output 3D splats for map coordinates corresponding to the physical world. Each 3D splat may be a rendering of volume data representing a map coordinate in a map coordinate plane that corresponds to a coordinate frame of the real-world environment. For example, the 3D splats may be placed at their respective map coordinates to create a representation of the physical world. In some embodiments, each 3D splat is represented by an ellipsoid at its corresponding mapping coordinate and has a particular size, color, and transparency.

The 3D foundation model is trained on a plurality of images captured by client devices 310 connected to the game server 320 such that the 3D foundation model is able to ascertain characteristics about physical locations based on its knowledge of other physical locations. For example, despite not having an image corresponding to a particular pose that shows one vantage point of a tennis court, the 3D foundation model 414 may generate a 3D splat for its associated map coordinates that includes representation of the tennis court, as determined based on the 3D foundation model's understanding of tennis courts from its training. In another example, the 3D foundation model 414 may generate a 3D splat for the physical location of a map coordinate during daytime, despite only having received images of the physical location at nighttime, based on its understanding of visual changes between daytime and nighttime. The geospatial localization module 328 receives 560 3D splats from the 3D foundation model 414. The geospatial localization module relocalizes 570 the client device 310 that captured the input image based on the 3D splats of map coordinates, such that the geospatial localization module 328 understands the pose of the client device 310 within the map representation of the physical world.

The geospatial localization module 328 may determine the pose of the camera that captured the input image(s) using the 3D splats. For instance, the geospatial localization module 328 may identify correspondences between features in the input image(s) and the 3D splats, and apply a pose estimation algorithm, such as a Perspective-n-Point (PnP) solver, to calculate the camera's position and orientation. In some embodiments, the geospatial localization module 328 may iteratively refine the pose by minimizing the reprojection error between the projected 3D splats and their observed locations within the input image(s). Alternatively, the geospatial localization module 328 may employ a direct optimization approach, adjusting the camera pose to minimize a photometric or geometric loss between the input image(s) and rendered projections of the 3D splats.

In some embodiments, the map representation is a neural network that connects visual data of each of a global set of images captured by a plurality of client devices 310 connected to the game server 320. The visual data may include a map code that includes scene specific information about scene depicted by each of the images in the global set, an appearance code that includes appearance information about the scene depicted by each image of the global set, and visual metadata that includes global positioning system (GPS) data, semantic features, and semantic labels captured with or in images in the global set.

In some embodiments, the geospatial localization module 328 receives user data captured by client devices 310. The user data may include images captured by the client devices 310 and metadata captured by the client devices 310. The geospatial localization module 328 determines the visual data based on the user data and stores the visual data in one or more neural representations that represent the real-world environment. In some embodiments, each neural map representation is associated with one or more map coordinates in the real-world environment.

### Example Computing System

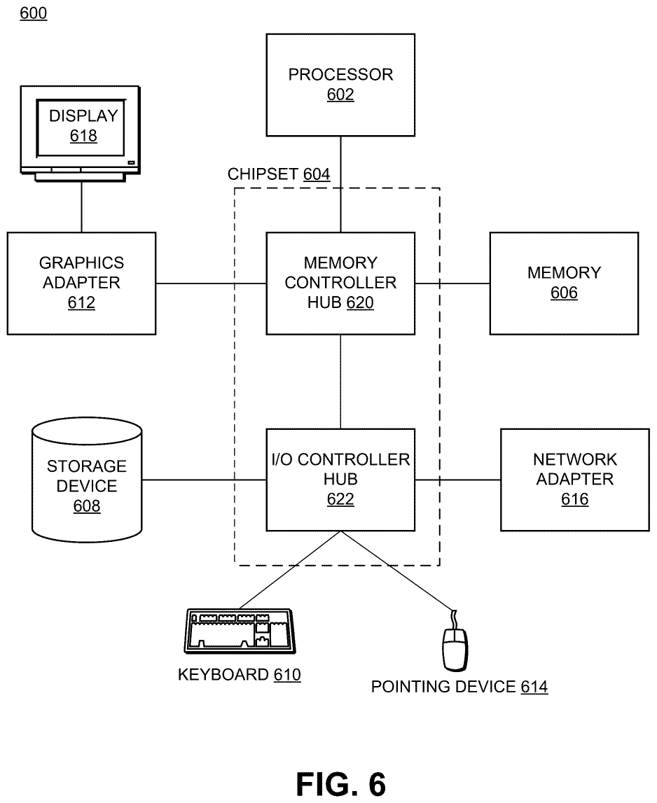

FIG. 6 is a block diagram of an example computer 600 suitable for use as a client device 310 or game server 320. The example computer 600 includes at least one processor 602 coupled to a chipset 604. References to a processor (or any other component of the computer 600) should be understood to refer to any one such component or combination of such components working cooperatively to provide the described functionality. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

In the embodiment shown in FIG. 6, the storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, touch-screen, or other type of pointing device, and may be used in combination with the keyboard 610 (which may be an on-screen keyboard) to input data into the computer system 600. The graphics adapter 612 displays images and other information on the display 618. The network adapter 616 couples the computer system 600 to one or more computer networks, such as network 370.

The types of computers used by the entities of FIGS. 3 and 4 can vary depending upon the embodiment and the processing power required by the entity. For example, the game server 320 might include multiple blade servers working together to provide the functionality described. Furthermore, the computers can lack some of the components described above, such as keyboards 610, graphics adapters 612, and displays 618.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. For example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
accessing an input image of a scene in a real-world environment from a mobile device;
applying a two-dimensional (2D) foundation model to the input image, wherein the 2D foundation model is trained to determine an image vector representing characteristics of the input image;
accessing a map representation of the real-world environment, wherein the map representation includes visual data that describes the real-world environment;
applying a three-dimensional (3D) geospatial model to the map representation and the image vector, wherein the 3D geospatial model is configured to output 3D splats representing the real-world environment; and
determining a pose of a camera that captured the input image using the 3D splats.

2. The computer-implemented method of claim 1, wherein the pose includes a position and orientation of the camera in the real-world environment.

3. The computer-implemented method of claim 1, wherein the map representation comprises a neural network that connects visual data of each of a global set of images captured by a plurality of mobile devices in the real-world environment.

4. The computer-implemented method of claim 3, wherein the visual data includes a map code that includes scene specific information about a scene depicted by each of the images in the global set, an appearance code that includes appearance information about the scene depicted by each image of the global set, and visual metadata that includes global positioning system (GPS) data, semantic features, and semantic labels captured with or in images in the global set.

5. The computer-implemented method of claim 1, further comprising:
receiving user data captured by mobile devices, wherein the user data includes images captured by the mobile devices and metadata captured by the mobile devices;
determining the visual data based on the user data, wherein the visual data includes map code, appearance code, and visual metadata for the real-world environment depicted in a respective image; and
storing the visual data in one or more neural representations that represent the real-world environment, each neural map representation associated with one or more map coordinates in the real-world environment.

6. The computer-implemented method of claim 1, wherein each 3D splat is a rendering of volume data representing a map coordinate in a map coordinate plane that corresponds to a coordinate frame of the real-world environment.

7. The computer-implemented method of claim 6, wherein each 3D splat is represented by an ellipsoid at its corresponding mapping coordinate and has a particular size, color, and transparency.

8. The computer-implemented method of claim 1, wherein the 2D foundation model and the 3D geospatial model together comprise an auxiliary model, wherein the auxiliary model is trained on images labeled with visual data captured by a respective mobile device that captured a respective image.

9. The computer-implemented method of claim 8, where labeled images are shuffled prior to training of the auxiliary model, wherein the shuffling creates an un-ordered set of labeled images on which the auxiliary model is trained.

10. The computer-implemented method of claim 1, wherein the image vector is one of a plurality of image vectors generated from the input image, each of the plurality of image vectors generated from a different patch of the input image, and wherein the 3D foundation model is applied to the map representation and the plurality of image vectors.

11. A non-transitory computer-readable storage medium storing instructions that, when executed by a processor, cause the processor to perform steps comprising:
accessing an input image of a scene in a real-world environment from a mobile device;
applying a two-dimensional (2D) foundation model to the input image, wherein the 2D foundation model is trained to determine an image vector representing characteristics of the input image;
accessing a map representation of the real-world environment, wherein the map representation includes visual data that describes the real-world environment;
applying a three-dimensional (3D) geospatial model to the map representation and the image vector, wherein the 3D geospatial model is configured to output 3D splats representing the real-world environment; and
determining a pose of a camera that captured the input image using the 3D splats.

12. The non-transitory computer-readable storage medium of claim 11, wherein the pose includes a position and orientation of the camera in the real-world environment.

13. The non-transitory computer-readable storage medium of claim 11, wherein the map representation comprises a neural network that connects visual data of each of a global set of images captured by a plurality of mobile devices in the real-world environment.

14. The non-transitory computer-readable storage medium of claim 13, wherein the visual data includes a map code that includes scene specific information about a scene depicted by each of the images in the global set, an appearance code that includes appearance information about the scene depicted by each image of the global set, and visual metadata that includes global positioning system (GPS) data, semantic features, and semantic labels captured with or in images in the global set.

15. The non-transitory computer-readable storage medium of claim 11, the steps further comprising:
receiving user data captured by mobile devices, wherein the user data includes images captured by the mobile devices and metadata captured by the mobile devices;
determining the visual data based on the user data, wherein the visual data includes map code, appearance code, and visual metadata for the real-world environment depicted in a respective image; and
storing the visual data in one or more neural representations that represent the real-world environment, each neural map representation associated with one or more map coordinates in the real-world environment.

16. The non-transitory computer-readable storage medium of claim 11, wherein each 3D splat is a rendering of volume data representing a map coordinate in a map coordinate plane that corresponds to a coordinate frame of the real-world environment.

17. The non-transitory computer-readable storage medium of claim 16, wherein each 3D splat is represented by an ellipsoid at its corresponding mapping coordinate and has a particular size, color, and transparency.

18. The non-transitory computer-readable storage medium of claim 11, wherein the 2D foundation model and the 3D geospatial model together comprise an auxiliary model, wherein the auxiliary model is trained on images labeled with visual data captured by a respective mobile device that captured a respective image.

19. The non-transitory computer-readable storage medium of claim 18, where labeled images are shuffled prior to training of the auxiliary model, wherein the shuffling creates an un-ordered set of labeled images on which the auxiliary model is trained.

20. A system comprising:
a processor; and
a non-transitory computer-readable storage medium storing instructions that, when executed by a processor, cause the processor to perform actions comprising:
accessing an input image of a scene in a real-world environment from a mobile device;
applying a two-dimensional (2D) foundation model to the input image, wherein the 2D foundation model is trained to determine an image vector representing characteristics of the input image;
accessing a map representation of the real-world environment, wherein the map representation includes visual data that describes the real-world environment;
applying a three-dimensional (3D) geospatial model to the map representation and the image vector, wherein the 3D geospatial model is configured to output 3D splats representing the real-world environment; and
determining a pose of a camera that captured the input image using the 3D splats.
